(19) United States
(12) Patent Application Publication
(10) Pub. No.: US 2026/0171519 A1
(43) Pub. Date: Jun. 18, 2026

(54) BATTERY SYSTEM

(71) Applicant: TOYOTA JIDOSHA KABUSHIKI KAISHA, Toyota-shi (JP)

(72) Inventors: Hirotaka ITO, Nagoya-shi (JP); Kenta ISHII, Seto-shi (JP)

(73) Assignee: TOYOTA JIDOSHA KABUSHIKI KAISHA, Toyota-shi (JP)

(21) Appl. No.: 19/389,127

(22) Filed: Nov. 14, 2025

(30) Foreign Application Priority Data
Dec. 12, 2024 (JP) 2024-217665

(51) Int. Cl. H01M 10/42; H01M 10/48; B60L 50/60

(52) U.S. Cl. CPC H01M 10/425; H01M 10/486; B60L 50/60; H01M 2220/20

(57) ABSTRACT

An ECU acquires the SOC, SOH, and degradation time. An anode degradation coefficient is calculated from the SOH and an effective temperature, and a time degradation coefficient is calculated from the degradation time and the effective temperature. The smaller of the anode degradation coefficient and the time degradation coefficient is calculated as an overall degradation coefficient, and an initial input current limit value is calculated from the SOC and the effective temperature. An input current limit value is calculated by multiplying the initial input current limit value by the overall degradation coefficient. The input current of the battery is controlled so as not to exceed the input current limit value. When an anode degradation factor (= SOH × anode resistance increase rate) is greater than 1, the anode degradation coefficient is set to the reciprocal of the anode degradation factor.

### CROSS-REFERENCE TO RELATED APPLICATION

This application claims priority to Japanese Patent Application No. 2024-217665 filed on December 12, 2024. The disclosure of the above-identified application, including the specification, drawings, and claims, is incorporated by reference herein in its entirety.

### BACKGROUND

### 1. Technical Field

The present disclosure relates to battery systems.

### 2. Description of Related Art

Japanese Unexamined Patent Application Publication No. 2021-125423 (JP 2021-125423 A) discloses charging current control for a lithium-ion battery. In this control, the anode potential is estimated using a map based on the state of charge (SOC) of the anode. When it is determined that the anode potential will fall below a threshold, the charging current is suppressed such that the anode potential does not fall below the threshold.

### SUMMARY

In JP 2021-125423 A, the charging current is controlled such that the anode potential does not fall below the threshold, thereby suppressing lithium deposition on the anode. However, in JP 2021-125423 A, the anode potential obtained from the map does not take degradation of the anode into account. Accordingly, the charging current control disclosed in JP 2021-125423 A may not sufficiently suppress lithium deposition on the anode when the battery has degraded.

An object of the present disclosure is to suppress lithium deposition on the anode even when the battery has degraded.

A battery system of the present disclosure is a battery system including: a battery containing lithium in an electrode; a temperature sensor configured to detect a battery temperature that is a temperature of a battery; a current sensor configured to detect input and output current of the battery; and a control device. The control device includes: a state-of-health (SOH) estimation unit configured to estimate the SOH of the battery; an anode degradation coefficient calculation unit configured to calculate an anode degradation coefficient based on the SOH and the battery temperature; and a limit value calculation unit configured to calculate an input current limit value based on the anode degradation coefficient. The control device is configured to control an input current of the battery such that the input current does not exceed the input current limit value.

When the battery degrades and the anode degrades, the potential of the anode (closed circuit potential (CCP)) changes based on the SOH and the anode resistance increase rate. The anode resistance increase rate varies depending on the SOH and the temperature of the battery. In this configuration, the battery is a lithium-ion battery that contains lithium in its electrode. The control device calculates the anode degradation coefficient based on the SOH and the battery temperature by the anode degradation coefficient calculation unit, and calculates the input current limit value based on the anode degradation coefficient by the limit value calculation unit. The control device controls the input current of the battery such that the input current does not exceed the input current limit value. The anode degradation coefficient is calculated based on the SOH and the battery temperature. Since the input current of the battery is limited based on the anode degradation coefficient, it is possible to suppress the anode potential from reaching or falling below the potential at which lithium deposition occurs even when the battery has degraded, thereby suppressing lithium deposition.

The control device may further include: a state-of-charge (SOC) calculation unit configured to calculate an SOC of the battery, and an initial limit value calculation unit configured to calculate an initial input current limit value based on the SOC and the battery temperature. The limit value calculation unit may be configured to calculate the input current limit value by multiplying the initial input current limit value by the anode degradation coefficient.

In this configuration, the SOC calculation unit calculates the SOC of the battery. The initial limit value calculation unit calculates the initial input current limit value, namely the limit value for the input current in the initial (brand-new) state of the battery, based on the SOC and the battery temperature. The initial input current limit value is a value that limits the input current such that lithium deposition on the anode occurs in the battery in the initial state. The limit value calculation unit calculates the input current limit value by multiplying the initial input current limit value by the anode degradation coefficient. The initial input current limit value is thus corrected by the anode degradation coefficient, thereby enabling suppression of lithium deposition on the anode even when the battery has degraded.

The anode degradation coefficient may be set based on an anode resistance increase rate of the battery and the SOH. When an anode degradation factor is defined as the SOH multiplied by the anode resistance increase rate, the anode degradation coefficient may be set to the reciprocal of the anode degradation factor when the anode degradation factor is greater than 1, and the anode degradation coefficient may be set to the anode degradation factor when the anode degradation factor is less than 1.

In this configuration, even when the anode resistance increase rate becomes large relative to the SOH, and the anode degradation factor exceeds 1, the anode degradation coefficient becomes a value less than 1. As a result, even in cases where the anode degradation is greater than the capacity degradation, the input current is limited such that the anode potential does not reach or fall below the potential at which lithium deposition occurs, thereby suppressing lithium deposition.

The battery may be configured as a battery pack, and a plurality of the temperature sensors may be provided. The anode degradation coefficient calculation unit may be configured to calculate the anode degradation coefficient based on the lowest battery temperature among the battery temperatures detected by the temperature sensors.

The anode resistance increase rate becomes greater as the battery temperature decreases. In this configuration, the anode degradation coefficient calculation unit calculates the anode degradation coefficient based on the lowest battery temperature among those detected by the temperature sensors. Therefore, even when the battery has degraded, the input current can be reliably limited such that the anode potential does not reach or fall below the potential at which lithium deposition occurs, thereby suppressing lithium deposition.

The control device may further include: a degradation time calculation unit configured to calculate a degradation time that is an elapsed time since the battery started being used; a time degradation coefficient calculation unit configured to calculate a time degradation coefficient based on the degradation time and the battery temperature; and a selection unit configured to select, as an overall degradation coefficient, either the anode degradation coefficient or the time degradation coefficient, whichever is smaller. The limit value calculation unit may be configured to calculate the input current limit value based on the overall degradation coefficient.

When the estimation accuracy of the SOH deteriorates, the anode degradation coefficient may be calculated to be larger than its actual value. As a result, the input current limit value may become large. If the input current limit value becomes large, there is a concern that the anode potential may reach or fall below the potential at which lithium deposition occurs. In the above configuration, the time degradation coefficient calculation unit calculates the time degradation coefficient based on the degradation time and the battery temperature. The time degradation coefficient is calculated based on the degradation time, namely the elapsed time since the battery started being used. Even when the SOH estimation accuracy deteriorates and the anode degradation coefficient is calculated to be larger than its actual value, the selection unit selects, as the overall degradation coefficient, the smaller of the anode degradation coefficient and the time degradation coefficient. The limit value calculation unit calculates the input current limit value based on the overall degradation coefficient. Accordingly, even when the SOH estimation accuracy deteriorates, the input current can be limited such that the anode potential does not reach or fall below the potential at which lithium deposition occurs, thereby suppressing lithium deposition.

The present disclosure makes it possible to suppress lithium deposition on the anode even when the battery has degraded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the overall configuration of an electrified vehicle equipped with a battery system according to an embodiment;

FIG. 2 is a flowchart illustrating an example of a limit value calculation process executed by an ECU;

FIG. 3 is a diagram illustrating the functional blocks of a limit value processing unit configured in the ECU; and

FIG. 4 is a flowchart of an input current limiting process executed by the ECU.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

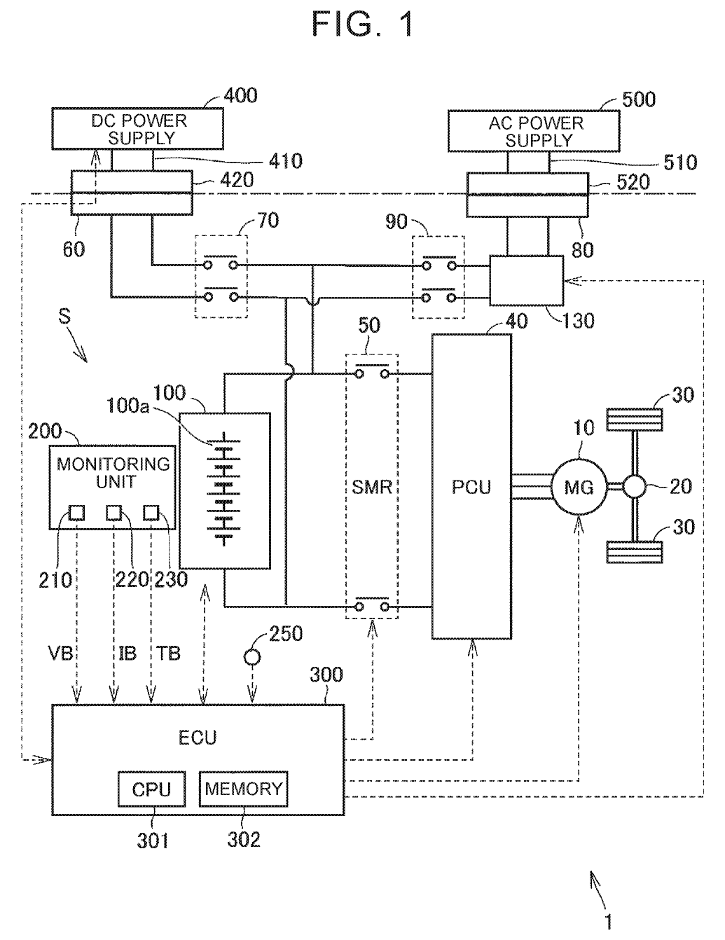

FIG. 1 is a diagram showing the overall configuration of an electrified vehicle 1 equipped with a battery system S according to an embodiment. In the present embodiment, the electrified vehicle 1 is, for example, a battery electric vehicle. The electrified vehicle 1 includes a motor generator (MG) 10 that is a rotating electrical machine, a power transmission gear 20, drive wheels 30, a power control unit (PCU) 40, a system main relay (SMR) 50, a battery 100, a monitoring unit 200, and an electronic control unit (ECU) 300 that is an example of a control device.

The MG 10 is, for example, an interior permanent magnet synchronous motor (IPM motor), and serves as both an electric motor and a generator. The output torque of the MG 10 is transmitted to the drive wheels 30 via the power transmission gear 20 that includes a reduction gear and a differential.

During braking of the electrified vehicle 1, the MG 10 is driven by the drive wheels 30 and operates as a generator. Accordingly, the MG 10 also serves as a braking device that performs regenerative braking to convert the kinetic energy of the electrified vehicle 1 into electric power. The regenerative power generated by the regenerative braking force of the MG 10 is stored in the battery 100.

The PCU 40 is a power conversion device that bidirectionally converts electric power between the MG 10 and the battery 100. The PCU 40 includes, for example, an inverter and a converter that operate based on control signals from the ECU 300.

During discharging of the battery 100, the converter boosts the voltage from the battery 100 and supplies the resulting voltage to the inverter. The inverter converts the direct current power supplied from the converter into alternating current power to drive the MG 10.

During charging of the battery 100 (i.e., during charging using regenerative power), the inverter converts the alternating current power generated by the MG 10 into direct current power and supplies it to the converter. The converter steps down the voltage supplied from the inverter to a voltage suitable for charging the battery 100 and supplies it to the battery 100.

The SMR 50 is electrically connected to a power line connecting the battery 100 and the PCU 40. When the SMR 50 is closed (ON) in response to a control signal from the ECU 300, electric power can be transferred between the battery 100 and the PCU 40. On the other hand, when the SMR 50 is open (OFF) in response to a control signal from the ECU 300, the electrical connection between the battery 100 and the PCU 40 is interrupted.

The battery 100 stores electric energy for driving the MG 10. The battery 100 is a rechargeable direct current power supply (secondary battery) and is configured as a battery pack in which a plurality of cells (battery cells) 100a is stacked and, for example, electrically connected in series. The battery 100 and the cells 100a correspond to the "battery" of the present disclosure. Each cell 100a is a lithium-ion cell including, for example, a cathode, an anode, and a separator (not shown). Alternatively, each cell 100a may be a solid-state lithium-ion cell. In the present embodiment, lithium iron phosphate cells (LFP cells), which use lithium iron phosphate as the cathode active material, are employed as the cells 100a.

The monitoring unit 200 includes a voltage sensor 210, a current sensor 220, and a temperature sensor 230. The voltage sensor 210 detects the voltage VB of each cell 100a (i.e., the voltage VB between the terminals of each cell 100a). The current sensor 220 detects the current (input and output current) IB input to and output from the battery 100 (each cell 100a). The input and output current IB may be positive (+) when charging the battery 100 and negative (−) when discharging the battery 100. The temperature sensor 230 detects the temperature TB of each cell 100a. Each of the detection units outputs its detection result to the ECU 300.

The electrified vehicle 1 is equipped with a DC inlet 60, allowing the battery 100 to be rapidly charged from an external direct current (DC) power supply that serves as charging equipment. The DC inlet 60 is configured to connect with a connector 420 provided at the distal end of a charging cable 410 of the charging equipment (external DC power supply) 400. A charging relay 70 is electrically connected to a power line connecting the DC inlet 60 and the battery 100. The charging relay 70 selectively supplies or cuts off power between the DC inlet 60 and the battery 100 in response to a control signal from the ECU 300. When the charging relay 70 is closed, external (rapid) charging of the battery 100 is performed.

The electrified vehicle 1 is equipped with an AC inlet 80, allowing the battery 100 to be normally charged from an external alternating current (AC) power supply that serves as charging equipment. The AC inlet 80 is configured to connect with a connector 520 provided at the distal end of a charging cable 510 of the external AC power supply (charging equipment) 500. An in-vehicle charger 130 is provided on a power line between the AC inlet 80 and the battery 100. The in-vehicle charger 130 converts alternating current power supplied from the external AC power supply into direct current power and adjusts the voltage to a level suitable for charging the battery 100. A charging relay 90 is electrically connected to a power line connecting the in-vehicle charger 130 and the battery 100. The charging relay 90 selectively supplies or cuts off power between the in-vehicle charger 130 and the battery 100 in response to a control signal from the ECU 300. When the charging relay 90 is closed, external (normal) charging of the battery 100 is performed. The DC inlet 60 and the AC inlet 80 may be configured as a common inlet.

The ECU 300 includes a central processing unit (CPU) 301 and a memory 302 (including, for example, a read-only memory (ROM) and a random access memory (RAM)). The ECU 300 controls various devices such that the electrified vehicle 1 attains a desired state, based on signals received from the monitoring unit 200, signals from various sensors (not shown) (e.g., an accelerator operation amount signal, a vehicle speed sensor, etc), and information stored in the memory 302 such as maps and programs. The ECU 300 also controls the PCU 40, the in-vehicle charger 130, the charging equipment 400, etc. to control the charging current (input current) to the battery 100. The battery system S includes the battery 100 (cells 100a), the monitoring unit 200, the ECU 300, etc.

During charging of the battery 100 (both external charging and charging using regenerative power), the potential of the anode may fall below a reference potential (metallic lithium potential), resulting in lithium deposition on the anode. Therefore, the ECU 300 controls the input current (charging current) such that the anode potential does not fall below the reference potential. For example, the ECU 300 controls the input current of the battery 100 such that it does not exceed an input current limit value (hereinafter sometimes referred to as "limit value").

In order to address degradation of the battery 100 (cells 100a), the limit value may be corrected based on the state of health (SOH) that represents the capacity retention rate. In a lithium-ion battery in which the cathode has a low potential and a stable crystal structure and exhibits a low resistance increase rate and small capacity degradation, such as the LFP battery of the present embodiment, it may be difficult to control the anode potential to remain above the potential at which lithium deposition occurs, even when the limit value is corrected based on SOH.

As the battery 100 (cells 100a) degrades, the anode potential (closed-circuit potential (CCP)) in response to the input current decreases compared to the initial (brand-new) state. When the battery 100 is energized (when current flows through the battery 100), the anode potential (CCP) can be expressed as "CCP = anode OCP − IB × R × SOHR." The anode OCP is the open-circuit potential (OCP) of the anode, IB is the current flowing through the anode (battery 100 (cells 100a)), and R is the resistance of the anode. SOHR is the anode degradation factor, and in the present embodiment, the anode degradation factor SOHR is defined as "SOHR = SOH × anode resistance increase rate." The anode resistance increase rate is the rate of increase in resistance of the anode due to anode degradation or the like, expressed relative to the resistance in the initial (brand-new) state, which is defined as 1 (100%). In the initial (brand-new, non-degraded) state, the anode degradation factor SOHR is 1, and the initial CCP is expressed as "CCP = anode OCP − IB × R."

For example, when the battery 100 has degraded such that the SOH is 90% and the anode resistance increase rate is 120%, the anode degradation factor SOHR becomes "SOHR = 0.9 × 1.2 = 1.08." In this case, the anode potential CCP becomes "CCP = anode OCP − IB × R × 1.08," resulting in a lowered anode potential. Therefore, in the present embodiment, the limit value is corrected using the anode degradation factor SOHR, thereby suppressing lithium deposition on the anode while taking degradation of the anode into account in addition to SOH. As a result, even when, due to degradation of the battery 100, the anode degradation (i.e., anode resistance increase rate) becomes greater than the capacity degradation (i.e., decrease in SOH), lithium deposition on the anode can still be suppressed.

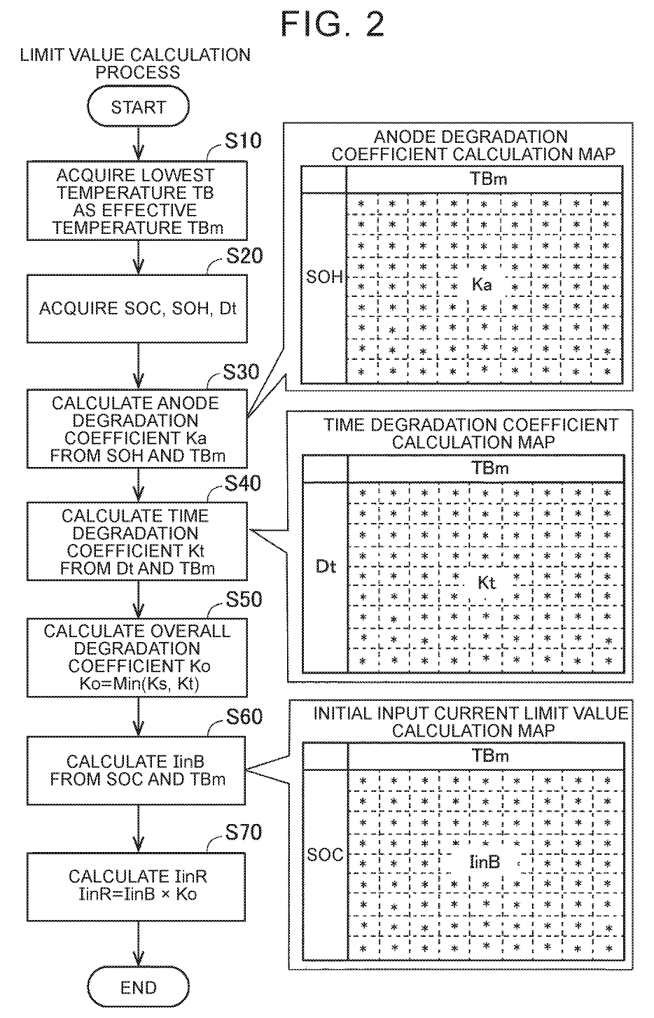

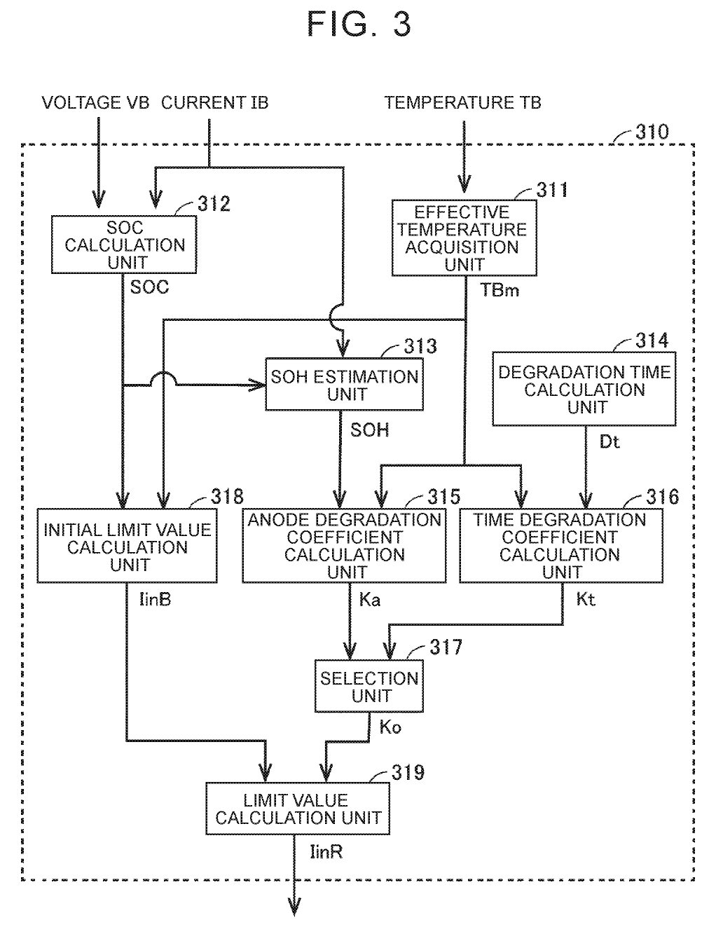

FIG. 2 is a flowchart illustrating an example of a limit value calculation process executed by the ECU 300. This flowchart is executed repeatedly at predetermined intervals while the battery 100 is being charged or discharged such as during travel of the electrified vehicle 1 or during external charging of the battery 100. FIG. 3 is a diagram illustrating the functional blocks of a limit value processing unit 310 configured in the ECU 300. The limit value calculation process is executed by the functional blocks of the limit value processing unit 310. The limit value calculation process will now be described with reference to FIGS. 2 and 3.

Referring to FIG. 2, in step (hereinafter abbreviated as "S") 10, the lowest of the temperatures TB of the cells 100a detected by the temperature sensor 230 of the monitoring unit 200 is acquired as the effective temperature TBm. The effective temperature TBm is acquired by an effective temperature acquisition unit 311 (see FIG. 3) of the limit value processing unit 310. When the temperature TB cannot be detected due to, for example, an abnormality in the temperature sensor 230 (e.g., a disconnection fault), a fixed value (e.g., −30°C) may be acquired as the effective temperature TBm.

In S20, the SOC, SOH, and degradation time Dt are acquired. Referring to FIG. 3, an SOC calculation unit 312 acquires the SOC of the battery 100. The SOC may be calculated, for example, from the voltage VB and the input and output current IB using open-circuit voltage (OCV)–SOC characteristics or the coulomb counting method.

The SOH is estimated by an SOH estimation unit 313. For example, the estimated SOH (%) is calculated using the estimated full charge capacity Ces (Ah), the initial full charge capacity Co (Ah), and a predetermined estimation equation. The estimation formula may be represented by, for example, "SOH = Ces/Co × 100." The initial full charge capacity Co refers to the full charge capacity in the non-degraded (initial) state. The initial full charge capacity Co may be a value determined in advance through experimentation etc. The estimated full charge capacity Ces is the estimated current full charge capacity. For example, the estimated full charge capacity Ces may be obtained based on the open-circuit voltages at the start and end of charging and the charging current integrated from the start to the end of charging. For example, the SOH estimation unit 313 may estimate the SOH when the battery 100 is externally charged. The estimated SOH is stored in the memory 302. In S20, the SOH is acquired by reading it from the memory 302.

The degradation time Dt is calculated by a degradation time calculation unit 314. The degradation time Dt is the elapsed time since the battery 100 started being used (i.e., since the initial state), and may be, for example, the cumulative time since the battery 100 was installed in the electrified vehicle 1. The degradation time calculation unit 314 may calculate the degradation time Dt as the value of a timer that starts when the battery 100 is installed in the electrified vehicle 1.

In S30, the anode degradation coefficient Ka is calculated from the SOH and the effective temperature TBm. The anode degradation coefficient Ka is calculated by an anode degradation coefficient calculation unit 315 based on the SOH estimated by the SOH estimation unit 313 and the effective temperature TBm. The anode degradation coefficient Ka is a coefficient determined by the anode resistance increase rate and the SOH of the battery 100 (cells 100a), and is set according to the anode degradation factor SOHR (= SOH × anode resistance increase rate). The anode resistance increase rate is the rate of increase in resistance of the anode due to anode degradation or the like, expressed relative to the resistance in the initial (brand-new) state, which is defined as 1 (100%).

When the anode degradation factor SOHR (= SOH × anode resistance increase rate) is less than 1 (SOHR < 1), the anode degradation coefficient Ka is set to the value of the anode degradation factor SOHR. When the anode degradation factor SOHR is greater than 1 (SOHR > 1), the anode degradation coefficient Ka is set to the reciprocal of the anode degradation factor SOHR (i.e., 1/SOHR). The anode resistance increase rate also varies depending on the temperature TB. Therefore, an anode degradation coefficient calculation map using SOH and effective temperature TBm as parameters is stored in the memory 302. The anode degradation coefficient calculation map is set in advance through experimentation etc. The anode degradation coefficient Ka is calculated from the anode degradation coefficient calculation map using SOH and effective temperature TBm as parameters.

In S40, a time degradation coefficient Kt is calculated from the degradation time Dt and the effective temperature TBm. The time degradation coefficient Kt is calculated by a time degradation coefficient calculation unit 316 based on the degradation time Dt calculated by the degradation time calculation unit 314 and the effective temperature TBm. Degradation of the battery 100 (cells 100a) may also manifest as changes in charge and discharge efficiency or input and output characteristics, in addition to a decrease in SOH.

When the SOH estimation accuracy deteriorates, the anode degradation coefficient Ka may be calculated to be larger than its actual value. In such cases, the anode potential may reach or fall below the potential at which lithium deposition occurs. The time degradation coefficient Kt is a coefficient determined by the time degradation of the battery 100 and the anode resistance increase rate, and is set according to a time degradation factor TDR. The time degradation is 100 (%) in the initial (brand-new) state, and decreases as the degradation time Dt increases. The time degradation factor TDR is calculated as "TDR = time degradation × anode resistance increase rate." When the time degradation factor TDR (= time degradation × anode resistance increase rate) is less than 1 (TDR < 1), the time degradation coefficient Kt is set to the value of the time degradation factor TDR. When the time degradation factor TDR is greater than 1 (TDR > 1), the time degradation coefficient Kt is set to the reciprocal of the time degradation factor TDR (i.e., 1/TDR). The anode resistance increase rate also varies depending on the temperature TB. Therefore, a time degradation coefficient calculation map using degradation time Dt and effective temperature TBm as parameters is stored in the memory 302. The time coefficient calculation map is set in advance through experimentation etc. The time degradation coefficient Kt is calculated from the time degradation coefficient calculation map using degradation time Dt and effective temperature TBm as parameters.

In S50, an overall degradation coefficient Ko is calculated. A selection unit 317 (see FIG. 3) selects the smaller of the anode degradation coefficient Ka and the time degradation coefficient Kt, and uses it as the overall degradation coefficient Ko.

In S60, an initial input current limit value IinB is calculated from the SOC and the effective temperature TBm. The initial input current limit value IinB is calculated by an initial limit value calculation unit 318 based on the SOC calculated by the SOC calculation unit 312 and the effective temperature TBm. The initial input current limit value IinB is the limit value for the input current in the initial (brand-new) state of the battery 100 (cells 100a), and is set such that the anode potential does not reach or fall below the potential at which lithium deposition occurs in the non-degraded (initial) state of the battery 100. An initial input current limit value calculation map using SOC and effective temperature TBm as parameters is stored in the memory 302. The initial input current limit value calculation map is set in advance through experimentation etc. The initial input current limit value IinB is calculated from the initial input current limit value calculation map using SOC and effective temperature TBm as parameters.

In S70, the input current limit value IinR is calculated, and the current routine ends. The input current limit value IinR is calculated by a limit value calculation unit 319 by multiplying the initial input current limit value IinB by the overall degradation coefficient Ko (IinR = IinB × Ko).

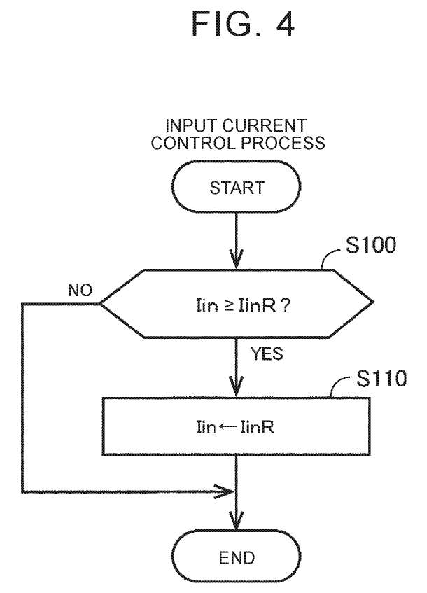

FIG. 4 is a flowchart of an input current limiting process executed by the ECU 300. This flowchart is executed repeatedly at predetermined intervals while the battery 100 is being charged or discharged such as during travel of the electrified vehicle 1 or during external charging of the battery 100. In S100, it is determined whether the input current command value Iin is greater than or equal to the input current limit value IinR. The input current command value Iin is a command value for the charging current (input current) of the battery 100. During travel of the electrified vehicle 1, the input current command value Iin is output to the PCU 40 as a current command value for regenerative power. During external charging, the input current command value Iin is output to the in-vehicle charger 130 and the charging equipment 400 as a current command value for charging power. When the input current command value Iin is less than the input current limit value IinR, the determination is negative and the current routine ends. In this case, the input current command value Iin is output to the PCU 40, the in-vehicle charger 130, and the charging equipment 400 as the current command value. The PCU 40, the in-vehicle charger 130, and the charging equipment 400 control the power supplied to the battery 100 such that the charging current of the battery 100 becomes the input current command value Iin.

When the input current command value Iin is greater than or equal to the input current limit value IinR in S100, the determination is affirmative, and the process proceeds to S110. In S110, the input current command value Iin is set to the input current limit value IinR, and the input current command value Iin is limited to the input current limit value IinR. Thereafter, the current routine ends. In this case, the input current command value Iin (= IinR), which has been limited to the input current limit value IinR, is output to the PCU 40, the in-vehicle charger 130, and the charging equipment 400 as the current command value, and the power supplied to the battery 100 is controlled such that the charging current of the battery 100 becomes the input current command value Iin (= IinR)

In addition to or instead of the processing of S100 and S110, the input current control process may control the charging power of the battery 100 such that the input current becomes smaller than the input current limit value IinR when the current IB detected by the current sensor 220 becomes greater than or equal to the input current limit value IinR.

According to the present embodiment, the anode degradation coefficient calculation unit 315 calculates the anode degradation coefficient Ka based on the SOH estimated by the SOH estimation unit 313 and the effective temperature TBm. The anode degradation coefficient Ka is set according to the anode degradation factor SOHR (= SOH × anode resistance increase rate). When the anode degradation factor SOHR is greater than 1, the anode degradation coefficient Ka is set to the reciprocal of the anode degradation factor SOHR, and when the anode degradation factor SOHR is less than 1, the anode degradation coefficient Ka is set to the value of the anode degradation factor SOHR.

The time degradation coefficient calculation unit 316 calculates the time degradation coefficient Kt based on the degradation time Dt and the effective temperature TBm. The time degradation coefficient Kt is a coefficient determined by the time degradation of the battery 100 and the anode resistance increase rate, and is set according to the time degradation factor TDR (= time degradation × anode resistance increase rate). When the time degradation factor TDR is less than 1, the time degradation coefficient Kt is set to the value of the time degradation factor TDR. When the time degradation factor TDR is greater than 1, the time degradation coefficient Kt is set to the reciprocal of the time degradation factor TDR.

The selection unit 317 selects the smaller of the anode degradation coefficient Ka and the time degradation coefficient Kt, and calculates it as the overall degradation coefficient Ko. The limit value calculation unit 319 calculates the input current limit value IinR by multiplying the initial input current limit value IinB by the overall degradation coefficient Ko. The input current of the battery 100 is controlled so as not to exceed the input current limit value IinR. As a result, the anode potential is less likely to reach or fall below the potential at which lithium deposition occurs, thereby suppressing lithium deposition.

According to the present embodiment, when the anode degradation factor SOHR is greater than 1, the anode degradation coefficient Ka by which the initial input current limit value IinB is to be multiplied is set to the reciprocal of the anode degradation factor SOHR (i.e., 1/SOHR). In this way, the anode potential is suppressed from reaching or falling below the potential at which lithium deposition occurs, while taking degradation of the anode into account in addition to the SOH. Therefore, even when the anode degradation (anode resistance increase rate) becomes greater than the capacity degradation (degradation with SOH as a parameter) due to degradation of the battery 100, lithium deposition on the anode can be suppressed.

According to the present embodiment, the smaller of the anode degradation coefficient Ka and the time degradation coefficient Kt is selected as the overall degradation coefficient Ko, and the input current limit value IinR is calculated by multiplying the initial input current limit value IinB by the overall degradation coefficient Ko. Accordingly, even when the estimation accuracy of the SOH deteriorates, lithium deposition can be suppressed by limiting the input current such that the anode potential does not reach or fall below the potential at which lithium deposition occurs.

As a modification, S40, S50, and S70 of the limit value calculation process (FIG. 2) may be omitted (the degradation time calculation unit 314, the time degradation coefficient calculation unit 316, and the selection unit 317 may be eliminated), and the input current limit value IinR may be calculated by multiplying the initial input current limit value IinB by the anode degradation coefficient Ka. In this modification as well, lithium deposition on the anode can be suppressed even when the anode degradation (anode resistance increase rate) becomes greater than the capacity degradation (degradation with SOH as a parameter) due to degradation of the battery 100.

In the above embodiment, lithium iron phosphate cells (LFP cells) are used as the cells 100a. However, the cells 100a may be of another type.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. A battery system comprising:
a battery containing lithium in an electrode;
a temperature sensor configured to detect a battery temperature that is a temperature of a battery; a current sensor configured to detect input and output current of the battery; and
a control device, wherein:
the control device includes
a state-of-health estimation unit configured to estimate a state of health of the battery,
an anode degradation coefficient calculation unit configured to calculate an anode degradation coefficient based on the state of health and the battery temperature, and
a limit value calculation unit configured to calculate an input current limit value based on the anode degradation coefficient; and
the control device is configured to control an input current of the battery such that the input current does not exceed the input current limit value.

2. The battery system according to claim 1, wherein:
the control device further includes
a state-of-charge calculation unit configured to calculate a state of charge of the battery, and
an initial limit value calculation unit configured to calculate an initial input current limit value based on the state of charge and the battery temperature; and
the limit value calculation unit is configured to calculate the input current limit value by multiplying the initial input current limit value by the anode degradation coefficient.

3. The battery system according to claim 2, wherein:
the anode degradation coefficient is set based on an anode resistance increase rate of the battery and the state of health; and
when an anode degradation factor is defined as the state of health multiplied by the anode resistance increase rate,
the anode degradation coefficient is set to a reciprocal of the anode degradation factor when the anode degradation factor is greater than 1, and
the anode degradation coefficient is set to the anode degradation factor when the anode degradation factor is less than 1.

4. The battery system according to claim 1, wherein:
the battery is configured as a battery pack, and a plurality of the temperature sensors is provided; and
the anode degradation coefficient calculation unit is configured to calculate the anode degradation coefficient based on a lowest battery temperature among the battery temperatures detected by the temperature sensors.

5. The battery system according to claim 4, wherein:
the control device further includes
a degradation time calculation unit configured to calculate a degradation time that is an elapsed time since the battery started being used,
a time degradation coefficient calculation unit configured to calculate a time degradation coefficient based on the degradation time and the battery temperature, and
a selection unit configured to select, as an overall degradation coefficient, either the anode degradation coefficient or the time degradation coefficient, whichever is smaller; and
the limit value calculation unit is configured to calculate the input current limit value based on the overall degradation coefficient.
